(19) United States
(12) Patent Application Publication
(10) Pub. No.: US 2010/0131332 A1
(43) Pub. Date: May 27, 2010

(54) TELEPHONE NUMBER BASED SYSTEM TO DELIVER COUPONS TO MOBILE DEVICES

(75) Inventors: Dilip Krishnaswamy, San Diego, CA (US); John Jozwiak, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/436,302

(22) Filed: May 6, 2009

Related U.S. Application Data
(60) Provisional application No. 61/118,140, filed on Nov. 26, 2008.

(51) Int. Cl. G06Q 30/00; H04W 4/12

(52) U.S. Cl. 705/10; 455/466; 705/14.64; 705/14.1

(57) ABSTRACT

Disclosed is a system to implement a method to deliver a coupon to a mobile device. A network entity may receive a telephone number from a mobile device operated by a caller. The network entity may obtaining identifying information about a target service provider as a function of the dialed telephone number. Using the identifying information about the target service provider, the network entity may obtain a coupon. The network entity then may send the coupon to the mobile device.

### CLAIM OF PRIORITY UNDER 35 U.S.C. §119

This application claims the benefit of and priority to commonly owned U.S. Provisional Patent Application No. 61/118,140, filed Nov. 26, 2008, and assigned Attorney Docket No. 082625P1, the disclosure of which is hereby incorporated by reference herein.

### BACKGROUND

1. Field

The following description relates generally to wireless communications, and more specifically to distributing coupons to mobile phones based on called telephone numbers.

2. Background

Coupons are advertising devices used by business to help persuade customers to return and redeem the coupon at their store. A main incentive for the consumer is savings since coupons may give a price reduction off the purchase of a product or service. Typically, manufacturers and retailers distribute coupons through newspapers, flyers, and mail circulars.

Recently, advertisers have taken to using the Internet to distribute coupons. Internet coupons are distributed to users at their desktop computers as printable coupons and coupon codes. Printable coupons include those coupons are available on the Internet that may be printed from a home computer and used in local stores. Coupon codes mostly are code numbers that may be entered into a portion of an online ordering form. The code engages a coupon that may be applied to the total purchase before the consumer makes the online payment. While distributing coupons over the Internet is a valuable way for businesses to advertise their services and customers to save money, their success is limited when it comes to enticing a seated computer user to get up and travel to a local store.

### SUMMARY

Disclosed is a system to implement a method to deliver a coupon to a mobile device. A network entity may receive a telephone number from a mobile device operated by a caller. The network entity may obtain identifying information about a target service provider as a function of the dialed telephone number. Using the identifying information about the target service provider, the network entity may obtain a coupon. The network entity then may send the coupon to the mobile device.

### BRIEF DESCRIPTION OF THE DRAWINGS

FIG. 1 illustrates an exemplary wireless communication system 100;

FIG. 2 illustrates an exemplary communication system 200;

FIG. 3 is a block diagram of a system 300 to deliver coupons to mobile devices;

FIG. 4 illustrates a method 400 to deliver coupons to mobile devices utilizing system 300;

FIG. 5 is a simplified block diagrams of several sample aspects of apparatuses configured to facilitate communication handoff as taught herein; and

FIG. 6 illustrates a Node B 20 and radio network controller 65 interface with a packet network interface 146.

FIG. 7 illustrates an embodiment of user equipment 10 which includes transmit circuitry 264 (including PA 328), receive circuitry 428, throttle control 326, decode process unit 258, processing unit 322, and memory 436.

In accordance with common practice, the various features illustrated in the drawings may not be drawn to scale. Accordingly, the dimensions of the various features may be arbitrarily expanded or reduced for clarity. In addition, some of the drawings may be simplified for clarity. Thus, the drawings may not depict all of the components of a given apparatus (e.g., device) or method. Finally, like reference numerals may be used to denote like features throughout the specification and figures.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing these aspects.

As used in this application, the terms “component”, “module”, “system”, and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

Furthermore, various aspects are described herein in connection with a mobile device. A mobile device may also be called, and may contain some or all of the functionality of a system, subscriber unit, subscriber station, mobile phone, mobile station, mobile, wireless terminal, device, remote station, remote terminal, access terminal, user terminal, terminal, wireless communication device, wireless communication apparatus, user agent, user device, or user equipment (UE). A mobile device may be a cellular telephone, a cellular mobile device, a cordless telephone, a Session Initiation Protocol (SIP) phone, a smart phone, a wireless local loop (WLL) station, a personal digital assistant (PDA), a laptop, a handheld communication device, a handset, a phone, a handheld computing device, a satellite radio, a wireless modem card and/or another processing device for communicating over a wireless system. Moreover, various aspects are described herein in connection with a base station. A base station may be utilized for communicating with wireless terminal(s) and also may be called, and may contain some or all of the functionality of, an access point, Node B, or some other network entity.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The word “exemplary” is used herein to mean “serving as an example, instance, or illustration.” Any embodiment described herein as “exemplary” is not necessarily to be construed as preferred or advantageous over other embodiments. The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” often are used interchangeably. A CDMA network may implement a radio technology such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS and LTE are described in documents from an organization named “3rd Generation Partnership Project” (3GPP). cdma2000 is described in documents from an organization named “3rd Generation Partnership Project 2” (3GPP2). 3GPP is a collaboration between groups of telecommunications associations, to make a globally applicable third generation (3G) mobile phone system specification within the scope of the International Mobile Telecommunications-2000 project of the International Telecommunication Union (ITU). 3GPP2 is a collaboration between telecommunications associations to make a globally applicable third generation (3G) mobile phone system specification within the scope of the ITU's International Mobile Telecommunications-2000 (IMT-2000) project. These various radio technologies and standards are known in the art.

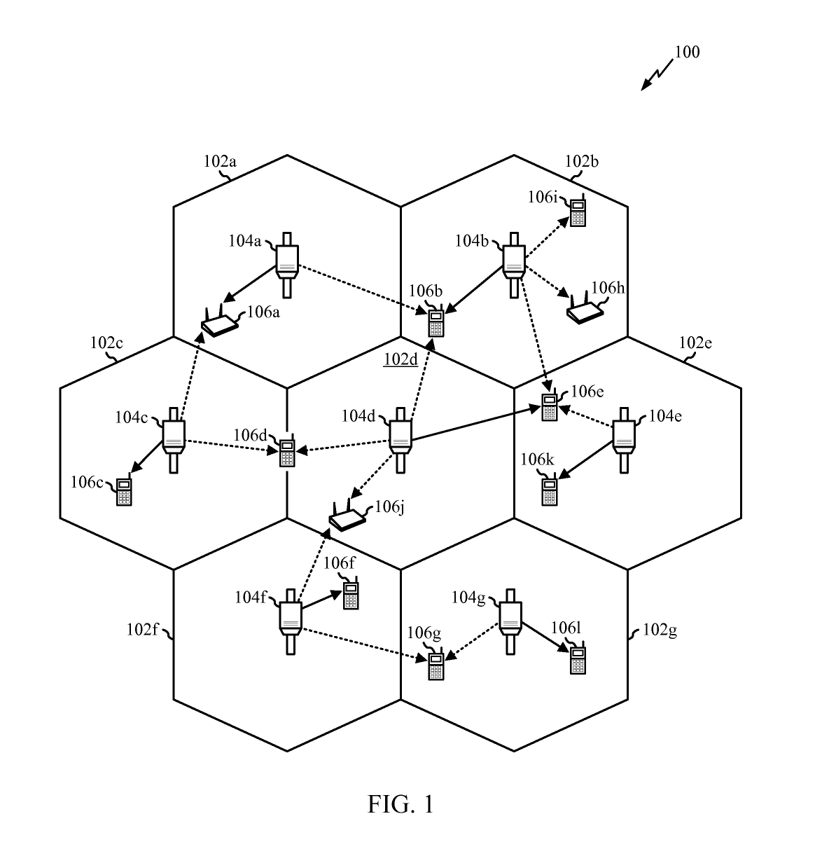

FIG. 1 illustrates an exemplary wireless communication system 100. Wireless communication system 100 may be configured to support the communication needs of a number of users, in which various disclosed embodiments and aspects may be implemented. As shown in FIG. 1, by way of example, system 100 provides communication for multiple cells 102, such as, for example, macro cells 102a-102g. Each macrocell 102 is an area of radio coverage in wireless communication system 100 served by one or more base stations. The wireless communication system 100 may provide service over a large geographic region, for example, macrocells 102a-102g may cover a few blocks in a neighborhood.

Each macrocell 102 may be serviced by a corresponding access point (AP) 104 (such as APs 104a-104g), such as by a macrocell base station. A macrocell base station may utilize power outputs of typically tens of watts to cover an outdoor cell site of about five kilometers in which the station may receive wireless signals from a relatively large number of mobile devices. The antennas for macrocells may be mounted on ground-based masts, rooftops and other existing structures, at a height that provides a clear view over the surrounding buildings and terrain.

Each macrocell 102 may be further divided into one or more sectors. Various access terminals (ATs) 106, including ATs 106a-106k, also known interchangeably as user equipment (UE) or mobile stations, may be dispersed throughout the system. Each AT 106 may communicate with one or more APs 104 on a forward link (FL) and/or a reverse link (RL) at a given moment, depending upon whether the AT is active and whether it is in soft handoff, for example.

ATs 106b-106g, 106i, and 106k-106l may be mobile phones, for example. The mobile phones may include portable telephones that may connect with a telephone network over radio wave transmission. ATs 106a, 106h, and 106j may be femtocell base stations. A femtocell base station is a small, box-sized device that may cover an indoor cell site of a few dozen to a couple hundred meters. A main advantage of a femtocell base station is that it allows users in and near a business, office, or home to use their mobile device without concern that the walls of their building will significantly weaken their signal.

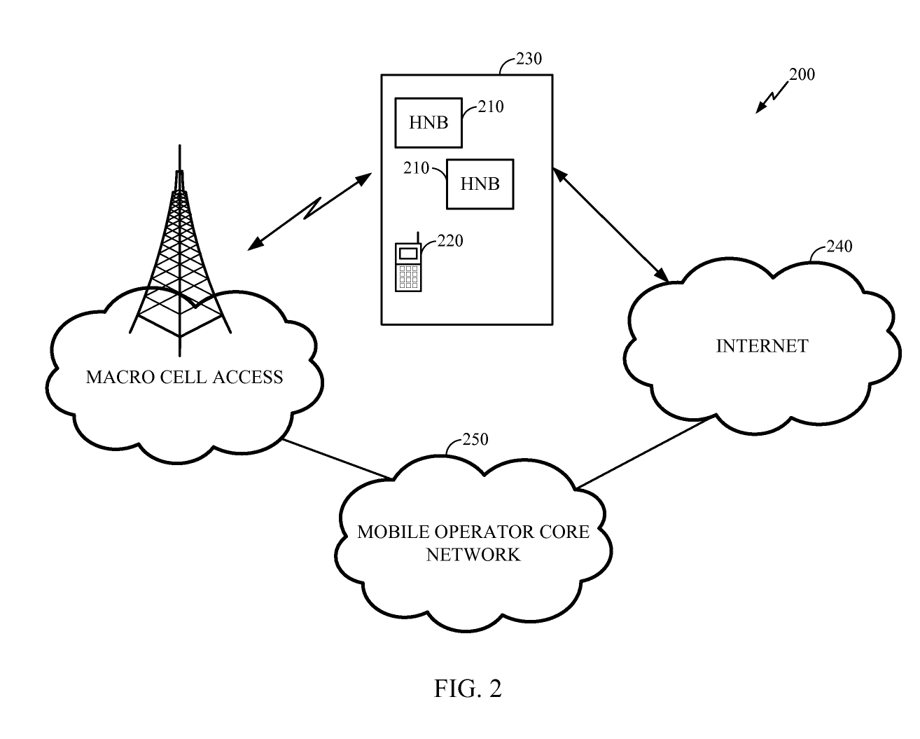

FIG. 2 illustrates an exemplary communication system 200. Communication system 200 may enable deployment of access point base stations within a network environment. As shown in FIG. 2, the system 200 includes multiple access point base stations or Home Node B units (HNBs) or femto cells, such as, for example, HNBs 210, each being installed in a corresponding small scale network environment 230, such as, for example, in one or more user residences or shopping mall, and being configured to serve associated, as well as alien, user equipment (UE) 220. Each HNB 210 is further coupled to the Internet 240 and a mobile operator core network 250 via a DSL router (not shown) or, alternatively, a cable modem (not shown).

Although embodiments described herein use 3GPP terminology, it is to be understood that the embodiments may be applied to 3GPP (Rel99, Rel5, Rel6, Rel7) technology, as well as 3GPP2 (1×RTT, 1×EV-DO Rel0, RevA, RevB) technology and other known and related technologies. In such embodiments described herein, the owner of the HNB 210 subscribes to mobile service, such as, for example, 3G mobile service, offered through the mobile operator core network 250, and the UE 220 is capable to operate both in macro cellular environment and in residential small scale network environment. Thus, the HNB 210 is backward compatible with any existing UE 220.

Furthermore, in addition to the macro cell mobile network 250, the UE 220 can only be served by a predetermined number of HNBs 210, namely the HNBs 210 that reside within the user's residence 230, and cannot be in a soft handover state with the macro network 250. The UE 220 can communicate either with the macro network 250 or the HNBs 210. As long as the UE 220 is authorized to communicate with the HNB 210, within the user's residence it is desired that the UE 220 communicate only with the associated HNBs 210.

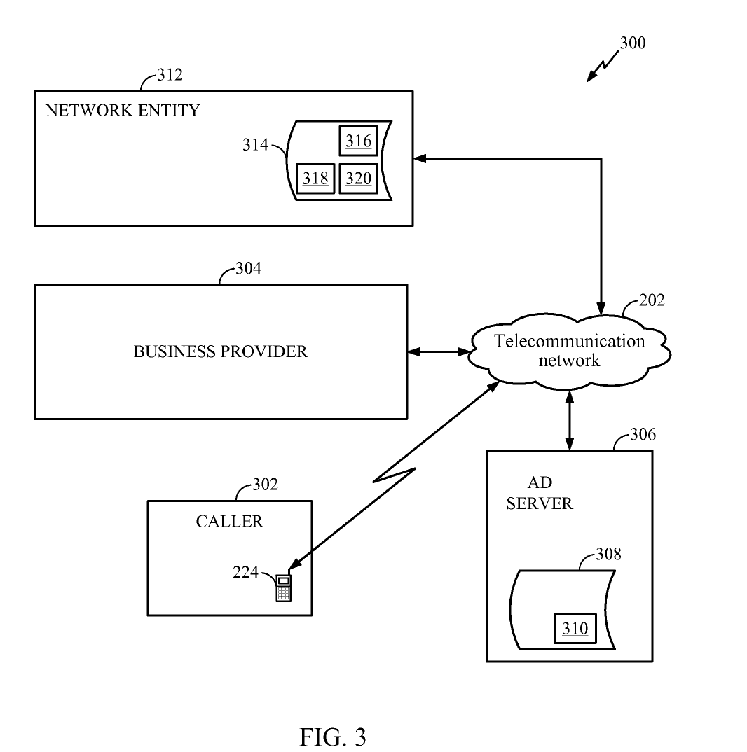

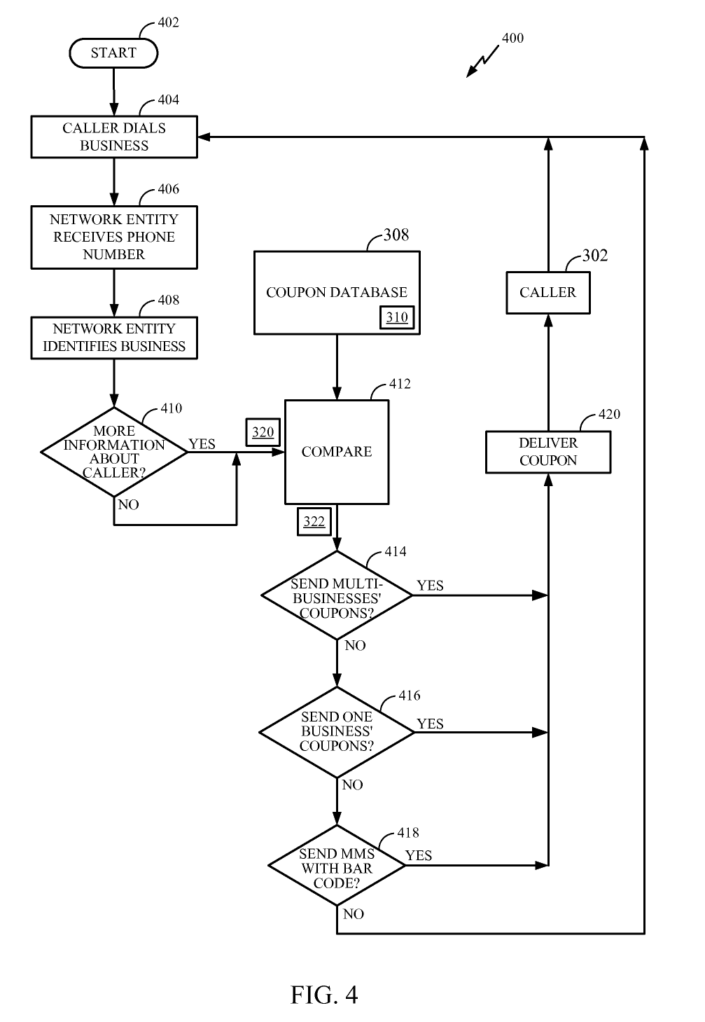

FIG. 3 is a block diagram of a system 300 to deliver coupons to mobile devices. FIG. 4 illustrates a method 400 to deliver coupons to mobile devices utilizing system 300. In system 300 and method 400, a caller 302, such as a user holding a mobile device 224, may represent the mobile devices. Caller 302 may make a call to a business provider 304. An ad server 306 may maintain a coupon database 308 storing coupons 310. Coupons 310 may include targeted content messages stored in a variety of forms that may be capable of being formatted into a variety of forms, such as a completed coupon to be transmitted through a text message, or an image of a coupon having a bar code that may be scanned, where the coupon may be transmitted as a Multimedia Messaging Service (MMS) message. System 300 further may include a telecommunication provider 312 having a profile database 314 that may house business information 316 and caller information 318. Telecommunication provider 312 may be a network entity 312. System 300 and method 400 may utilize part or all of wireless communication system 100 and/or telecommunication system 200.

Method 400 may start at step 402. At step 404, caller 302 may call a business provider 302. Calling a business may include caller 302 inputting numbers into the mobile device 224 that may correspond with a particular business provider 304, such as a restaurant or other goods or service provider. The dialed numbers may be transmitted into telecommunication network 202 (FIG. 3).

At step 406, network entity 312 may receive a copy of the telephone number dialed by caller 302. Network entity 312 may be an object distinguishable from other objects in communication with each other through an interconnected system, such a wireless communication system 100 and communication system 200. The telephone number may have been transmitted over system 100 or system 200 to network entity 312.

In one example, the telephone number may be a sequence of numbers used to call from one telephone line to another in a telephone network. The telephone number may contain information that may be used to identify uniquely the intended endpoint for the telephone call. In the present example, the intended endpoint for the telephone call may be business provider 304 and profile database 314 may house business information 316 about business provider 304. As step 408, network entity 312 may utilize the received telephone number to obtain identifying information from profile database 314 about business provider 304.

At step 410, network entity 312 may determine whether it has identifying information 318 about caller 302 within profile database 314. An example of identifying information about caller 302 may be an exportable version of the profile of the caller, including identity (e.g., name, age, gender), preferences, likes, and dislikes.

For example, if network entity 312, knows that caller 302 is a teenager or a middle aged person such as through an exportable version of the profile of the caller, then system 300 may send a more relevant version of the coupon to caller 302. If network entity 312 determines that it does have additional information on caller 302, then method 400 may proceed to step 412 with both business information 316 and caller information 318 as gathered information 320. If network entity 312 determines that it does not have additional information on caller 302, then method 400 may proceed to step 412 with the business information 316 about business provider 304 as gathered information 320.

At step 412, method 400 may compare gathered information 320 to coupons 310 in coupon database 308 to obtain a coupon set 322. In general, coupon set 322 may be a function of the telephone number dialed by caller 302. Caller 302 may have entered a telephone number into the mobile device and each coupon may include a price reduction or other incentive for caller 302 using the mobile device to return and redeem the coupon at the target service provider of the dialed telephone number. Coupon set 322 may include coupons of business provider 304 and include coupons for all service providers similar to business provider 304.

In the present example, coupon set 322 may include the restaurant coupons and coupons for other restaurants, such as those restaurants located near the called business and/or those restaurants serving similar cuisine or within a similar price range. A service sector may involve the provision of services to businesses as well as final consumers, such as the transport, distribution, and sale of goods from producer to a consumer in wholesaling and retailing and such as providing a service, such as in pest control, food, or entertainment. Here, target business provider 304 and service providers other than the target service provider may have a relation by being in the same service sector.

At step 414, method 400 may determine whether to send text message coupons to caller 302 for more than one business. The coupons for more than one business may include coupons for business provider 304 and coupons for providers similar to business provider 304. If method 400 determines to send text message coupons for more than one business, then method 400 may proceed to step 420 to send those text message coupons to the mobile device utilized by caller 302. The coupons may be sent to caller 302 by network entity 312 in a form of text message with a coupon for each service provider. If method 400 determines not to send coupons for more than one business, then method 400 may proceed to step 416.

At step 416, method 400 may determine whether to send a text message coupon to caller 302 for the target service provider of the dialed telephone number; that is to say, determine whether to send caller 302 a text message coupon for business provider 304 only. If method 400 determines to send caller 302 a text message coupon for business provider 304, then method 400 may proceed to step 420 to send that text message coupon to the mobile device utilized by caller 302. Here, network entity 312 may send caller 302 a text message with a coupon for the restaurant. If method 400 determines not to send caller 302 a text message coupon for business provider 304, then method 400 may proceed to step 418.

At step 418, method 400 may determine whether to send caller 302 a coupon image. If method 400 determines to send caller 302 a coupon image, then method 400 may proceed to step 420 to send caller 302 a MMS with an image of a coupon with a bar code that can be scanned. If method 400 determines not to send caller 302 a coupon image, then method 400 may return to step 404.

At step 420, method 400 may send caller 302 a targeted content message, such as a coupon. The coupon may be delivered to caller 302's mobile device 224. Method 400 then may return to step 404.

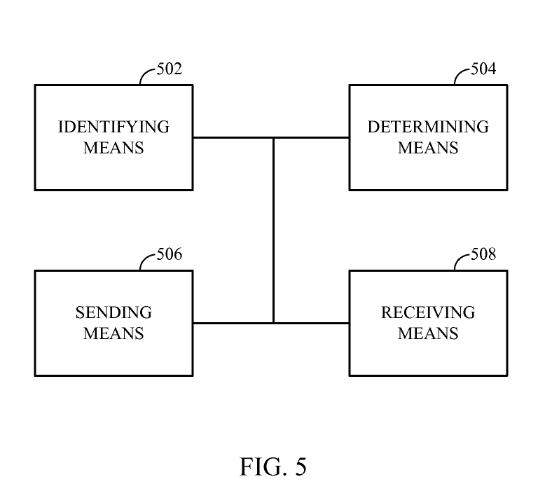

FIG. 5 is a simplified block diagrams of several sample aspects of apparatuses configured to facilitate communication handoff as taught herein. The components described herein may be implemented in a variety of ways. Referring to FIG. 5, apparatus 500 is represented as a series of interrelated functional blocks. The function block diagram may describe a function between input variables and output variables utilizing a set of elementary blocks where input and output variables may be connected to blocks by connection lines and an output of a block also may be connected to an input of another block. In some aspects, the functionality of these blocks may be implemented as a processing system including one or more processor components. In some aspects, the functionality of these blocks may be implemented using, for example, at least a portion of one or more integrated circuits (e.g., an ASIC). As discussed herein, an integrated circuit may include a processor, software, other related components, or some combination thereof. The functionality of these blocks also may be implemented in some other manner as taught herein. The apparatus 500 may include one or more modules that may perform one or more of the functions described above with regard to various figures. Apparatus 500 may include an identifying means 502, a determining means 504, a sending means 506, and a receiving means 508, each configured to be in communication with other elements of apparatus 500. Outputs of identifying means 502 and determining means 504 may be transmitted between sending means 506 and receiving means 508.

Identifying means 502 may correspond to, for example, a mobile device set identifier such as for mobile devices presently in communication with the femtocell base station and whose unique identifiers are preregistered with the femtocell base station and such as discussed herein. Identifying means 502 may correspond to a processor such as discussed herein. The processor may instruct a receiver to monitor for signals on an uplink and instruct a processor to process any signals received by the receiver. The processor may attempt to demodulate and decode received signals. The processor may generate information relating to acquired signals. The processor may be a central processing unit and may be a machine that can execute computer programs.

A determining means 504 may correspond to, for example, a processor as discussed herein. Determining means 504 may correspond to, for example, a signal processor as discussed herein. The processor may determine whether a received call includes one of a unique identifier of a target mobile device and a unique identifier of the femtocell base station. The processor may determine whether a second mobile device answered a paging message if the call is for the second mobile device. The processor may determine whether a first mobile device answered a paging message if the second mobile device did not answer the call, determine whether to disconnect the first mobile device from a traffic channel with the femtocell base station if the second mobile device answered the paging message and the first mobile device answered the paging message, and determine whether a conference call feature has been enabled in the femtocell base station. In addition, the processor may determine whether to block the second mobile device from answering the paging message if the first mobile device answered the paging message.

A sending means 506 may correspond to, for example, a device such a transceiver to send a paging message from the femtocell base station as discussed herein. Sending means 506 may correspond to, for example, a controller as discussed herein. A receiving means 508 may correspond to, for example, a transceiver to receive a call in the femtocell base station as discussed herein. Receiving means 508 may correspond to, for example, a communication controller as discussed herein. One transceiver may communicate with other transceivers and with other nodes. Each transceiver may include a respective transmitter to send signals and a respective receiver to receive signal. Each transceiver may receive and process a respective information stream to provide one or more analog signals, and further conditions (e.g., amplifies, filters, and upconverts) the analog signals to provide a modulated signal suitable for transmission. A transceiver may include at least one of a transmitter and a receiver, where a transmitter and receiver may be combined and share common circuitry or a single housing.

Communication systems may use a single carrier frequency or multiple carrier frequencies. Each link may incorporate a different number of carrier frequencies. Furthermore, an access terminal 10 may be any data device that communicates through a wireless channel or through a wired channel, for example using fiber optic or coaxial cables. An access terminal 10 may be any of a number of types of devices including but not limited to PC card, compact flash, external or internal modem, or wireless or wireline phone. The access terminal 10 is also known as user equipment (UE), a remote station, a mobile station or a subscriber station. Also, the UE 10 may be mobile or stationary.

User equipment 10 that has established an active traffic channel connection with one or more Node Bs 20 is called active user equipment 10, and is said to be in a traffic state. User equipment 10 that is in the process of establishing an active traffic channel connection with one or more Node Bs 20 is said to be in a connection setup state. User equipment 10 may be any data device that communicates through a wireless channel or through a wired channel, for example using fiber optic or coaxial cables. The communication link through which the user equipment 10 sends signals to the Node B 20 is called a uplink. The communication link through which an Node B 20 sends signals to a user equipment 10 is called a downlink.

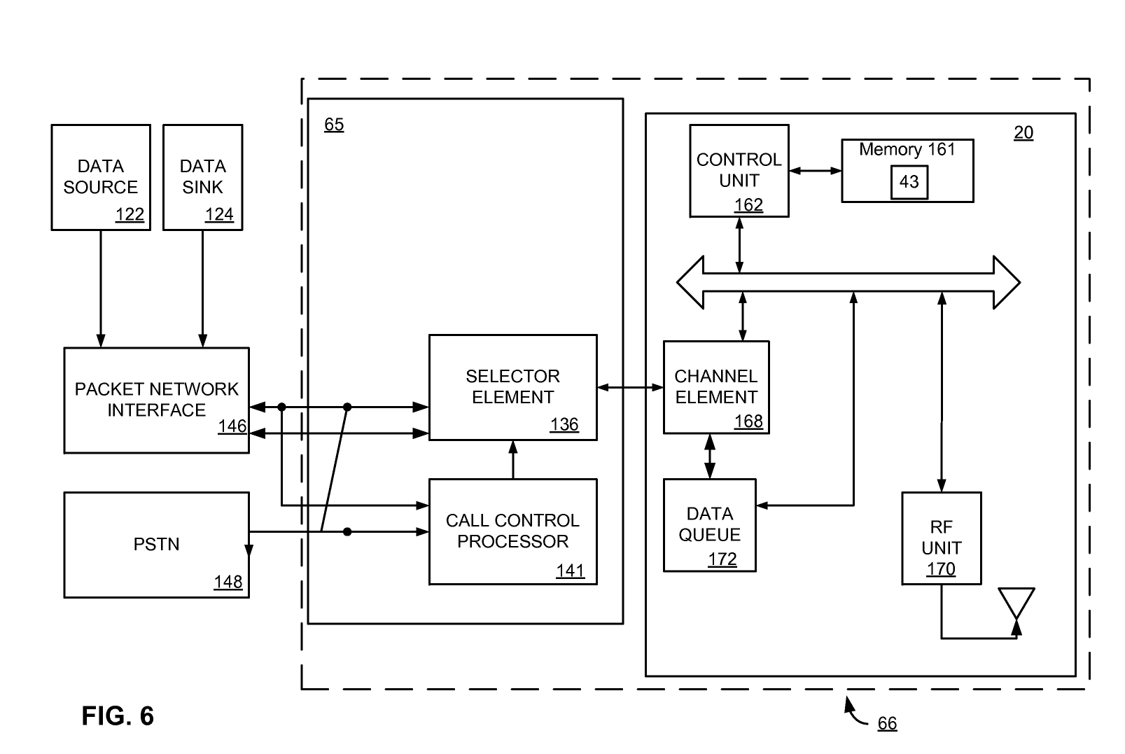

FIG. 6 is detailed herein below, wherein specifically, a Node B 20 and radio network controller 65 interface with a packet network interface 146. The Node B 20 and radio network controller 65 may be part of a radio network server (RNS) 66. The associated quantity of data to be transmitted is retrieved from a data queue 172 in the Node B 20 and provided to the channel element 168 for transmission to the remote station 10 associated with the data queue 172.

Radio network controller 65 interfaces with packet network interface 146, Public Switched Telephone Network (PSTN) 148, and all Node Bs 20 in the communication system 100 (only one Node B 20 is shown in FIG. 6 for simplicity). Radio network controller 65 coordinates the communication between remote stations 10 in the communication system and other users connected to packet network interface 146 and PSTN 148. PSTN 148 interfaces with users through a standard telephone network (not shown in FIG. 6).

Radio network controller 65 contains many selector elements 136, although only one is shown in FIG. 6 for simplicity. Each selector element 136 is assigned to control communication between one or more Node B's 20 and one remote station 10 (not shown). If selector element 136 has not been assigned to a given user equipment 10, call control processor 141 is informed of the need to page the remote station. Call control processor 141 then directs Node B 20 to page the remote station 10.

Data source 122 contains a quantity of data, which is to be transmitted to a given remote station 10. Data source 122 provides the data to packet network interface 146. Packet network interface 146 receives the data and routes the data to the selector element 136. Selector element 136 then transmits the data to Node B 20 in communication with the target remote station 10. In the exemplary embodiment, each Node B 20 maintains a data queue 172, which stores the data to be transmitted to the remote station 10.

For each data packet, channel element 168 inserts the necessary control fields. In the exemplary embodiment, channel element 168 performs a cyclic redundancy check, CRC, encoding of the data packet and control fields and inserts a set of code tail bits. The data packet, control fields, CRC parity bits, and code tail bits comprise a formatted packet. In the exemplary embodiment, channel element 168 then encodes the formatted packet and interleaves (or reorders) the symbols within the encoded packet. In the exemplary embodiment, the interleaved packet is covered with a Walsh code, and spread with the short PNI and PNQ codes. The spread data is provided to RF unit 170 which quadrature modulates, filters, and amplifies the signal. The downlink signal is transmitted over the air through an antenna to the downlink.

At the user equipment 10, the downlink signal is received by an antenna and routed to a receiver. The receiver filters, amplifies, quadrature demodulates, and quantizes the signal. The digitized signal is provided to a demodulator (DEMOD) where it is despread with the short PNI and PNQ codes and decovered with the Walsh cover. The demodulated data is provided to a decoder which performs the inverse of the signal processing functions done at Node B 20, specifically the de-interleaving, decoding, and CRC check functions. The decoded data is provided to a data sink.

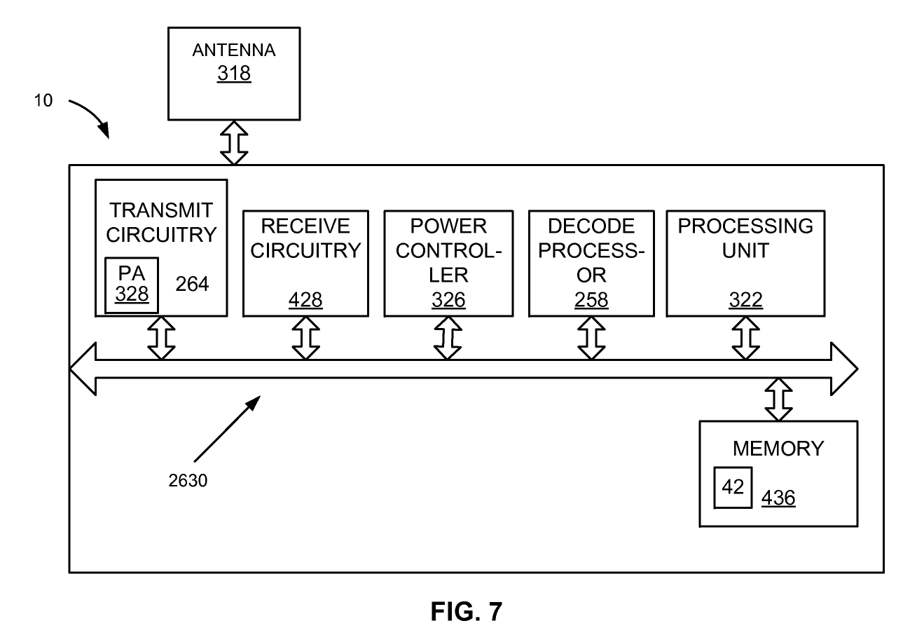

FIG. 7 illustrates an embodiment of a UE 10 according to the present patent application in which the UE 10 includes transmit circuitry 264 (including PA 328), receive circuitry 428, throttle control 326, decode process unit 258, processing unit 322, and memory 436.

The processing unit 322 controls operation of the UE 10. The processing unit 322 may also be referred to as a CPU. Memory 436, which may include both read-only memory (ROM) and random access memory (RAM), provides instructions and data to the processing unit 322. A portion of the memory 436 may also include non-volatile random access memory (NVRAM).

The UE 10, which may be embodied in a wireless communication device such as a cellular telephone, may also include a housing that contains a transmit circuitry 264 and a receive circuitry 428 to allow transmission and reception of data, such as audio communications, between the UE 10 and a remote location. The transmit circuitry 264 and receive circuitry 428 may be coupled to an antenna 318.

The various components of the UE 10 are coupled together by a bus system 2630 which may include a power bus, a control signal bus, and a status signal bus in addition to a data bus. However, for the sake of clarity, the various busses are illustrated in FIG. 7 as the bus system 2630. The UE 10 may also include a processing unit 322 for use in processing signals. Also shown are a power controller 326, a decode processor 258, and a power amplifier 328.

The steps illustrated in FIG. 7 may be stored as instructions in the form of software or firmware 42 located in memory 436 in the UE 10. It may also be stored in the form of software or firmware 43 located in memory 161 in the Node B 20.

While the specification describes particular examples of the present invention, those of ordinary skill can devise variations of the present invention without departing from the inventive concept. For example, the teachings herein refer to circuit-switched network elements but are equally applicable to packet-switched domain network elements.

Those skilled in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those skilled in the art will further appreciate that the various illustrative logical blocks, modules, circuits, methods and algorithms described in connection with the examples disclosed herein may be implemented as electronic hardware, computer software, or combinations of both. To clearly illustrate this interchangeability of hardware and software, various illustrative components, blocks, modules, circuits, methods and algorithms have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the examples disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

The methods or algorithms described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor. The processor and the storage medium may reside in an ASIC. Additionally, in some aspects, the steps and/or actions of a method or algorithm may reside as one or any combination or set of codes and/or instructions on a machine readable medium and/or computer readable medium, which may be incorporated into a computer program product.

Part or all of system 100, system 200, and method 400 may be implemented as a computer program product on a storage medium having instructions stored thereon/in. These instructions may be used to control, or cause, a computer to perform any of the processes. For example, a computer may execute a computer readable medium having a set of instructions which, when executed by a computer, cause the computer to deliver a coupon to a mobile device using method 400. The storage medium may include without limitation any type of disk including floppy disks, mini disks (MD's), optical disks, DVDs, CD-ROMs, micro-drives, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any type of media or device suitable for storing instructions and/or data.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed examples is provided to enable any person skilled in the art to make or use the present invention. Various modifications to these examples will be readily apparent to those skilled in the art, and the generic principles defined herein may be applied to other examples without departing from the spirit or scope of the invention. Thus, the present invention is not intended to be limited to the examples shown herein but is to be accorded the widest scope consistent with the principles and novel features disclosed herein.

What is claimed is:

1. A method to deliver a coupon to a mobile device, the method comprising:
receiving a telephone number from a mobile device operated by a caller;
identifying information about a target service provider as a function of the dialed telephone number;
identifying a coupon as a function of the information about the target service provider; and
sending the coupon to the mobile device.

2. The method of claim 1, where identifying a coupon further includes identifying a coupon as a function of information about the caller.

3. The method of claim 1, further comprising:
sending additional coupons to the mobile device, where those additional coupons are for service providers other than the target service provider and have a relation with the target service provider.

4. The method of claim 3, where the relation with the target service provider is that both the target service provider and the service providers other than the target service are in the same service sector.

5. The method of claim 1, where the coupons are sent to the mobile device as part of a text message.

6. The method of claim 1, where the coupons are sent to the mobile device as part of a Multimedia Messaging Service message having an image of a coupon with a bar code.

7. A apparatus to deliver a coupon to a mobile device, the apparatus comprising:
means for receiving a telephone number from a mobile device operated by a caller;
means for identifying information about a target service provider as a function of the dialed telephone number;
means for identifying a coupon as a function of the information about the target service provider; and
means for sending the coupon to the mobile device.

8. The apparatus of claim 7, where the means for identifying a coupon further includes means for identifying a coupon as a function of information about the caller.

9. The apparatus of claim 7, further comprising:
means for sending additional coupons to the mobile device, where those additional coupons are for service providers other than the target service provider and have a relation with the target service provider.

10. The apparatus of claim 9, where the relation with the target service provider is that both the target service provider and the service providers other than the target service are in the same service sector.

11. The apparatus of claim 7, where the coupons are sent to the mobile device as part of a text message.

12. The apparatus of claim 7, where the coupons are sent to the mobile device as part of a Multimedia Messaging Service message having an image of a coupon with a bar code.

13. An apparatus to deliver a coupon to a mobile device, the apparatus comprising:
a transceiver configured to receive a telephone number from a mobile device operated by a caller; and
an identifier configured to identify information about a target service provider as a function of the dialed telephone number and to identify a coupon as a function of the information about the target service provider,
where the transceiver further is configured to send the coupon to the mobile device.

14. The apparatus of claim 13, where the identifier further is configured to identify the coupon as a function of information about the caller.

15. The apparatus of claim 13, where the transceiver further is configured to send additional coupons to the mobile device, where those additional coupons are for service providers other than the target service provider and have a relation with the target service provider.

16. The apparatus of claim 15, where the relation with the target service provider is that both the target service provider and the service providers other than the target service are in the same service sector.

17. The apparatus of claim 13, where the coupons are sent to the mobile device as part of a text message.

18. The apparatus of claim 13, where the coupons are sent to the mobile device as part of a Multimedia Messaging Service message having an image of a coupon with a bar code.

19. A computer readable medium comprising a set of instructions which, when executed by a computer, cause the computer to deliver a coupon to a mobile device, the instructions for:
receiving a telephone number from a mobile device operated by a caller;
identifying information about a target service provider as a function of the dialed telephone number;
identifying a coupon as a function of the information about the target service provider; and
sending the coupon to the mobile device.

20. The computer readable medium of claim 19, where identifying a coupon further includes identifying a coupon as a function of information about the caller.

21. The computer readable medium of claim 19, further comprising:
sending additional coupons to the mobile device, where those additional coupons are for service providers other than the target service provider and have a relation with the target service provider.

22. The computer readable medium of claim 21, where the relation with the target service provider is that both the target service provider and the service providers other than the target service are in the same service sector.

23. The computer readable medium of claim 19, where the coupons are sent to the mobile device as part of a text message.

24. The computer readable medium of claim 19, where the coupons are sent to the mobile device as part of a Multimedia Messaging Service message having an image of a coupon with a bar code.
